(19) United States
(12) Patent Application Publication
(10) Pub. No.: US 2025/0356317 A1
(43) Pub. Date: Nov. 20, 2025

(54) SYSTEM AND METHOD FOR TRANSFORMING NATURAL LANGUAGE INTO A SYNTHETIC PROFILE

(71) Applicant: iCIMS, Inc., Holmdel, NJ (US)

(72) Inventor: Alina ZHILTSOVA, Dublin (IE)

(21) Appl. No.: 18/668,983

(22) Filed: May 20, 2024

(51) Int. Cl. G06Q 10/1053; G06F 40/30

(52) U.S. Cl. CPC G06Q 10/1053; G06F 40/30

(57) ABSTRACT

A representation of a text associated with an occupational code is received. A representation of a criterion associated with the text is received. A representation of a subset of text is extracted from the text. For each text from the subset of text and not for remaining text from the text, and to generate a set of candidate texts associated with the subset of text, text from a plurality of texts included in a database that have semantic similarity to that text greater than a predetermined threshold are identified. A subset of candidate texts is identified from the set of candidate texts based on the criterion. A synthetic profile associated with the text is generated using a machine learning model and based on the subset of candidate texts. A representation of the synthetic profile is caused to be output.

### FIELD

One or more embodiments are related to a system and method for transforming natural language into a synthetic profile.

### BACKGROUND

Human resources (HR) departments sometimes produce job descriptions that do not attract suitable candidates. That might be due to several factors such as outdated skills in the job description or requirements in the job description that are too vague or too specific. These job descriptions, as a result, make the hiring process longer and less efficient, as a recruiter looks through multiple unfitting candidate profiles. Candidates lose out as well, as they only see poor-fitting job descriptions and miss out on applying to other job descriptions that they are well qualified for.

### SUMMARY

In an embodiment, a method includes receiving, via a processor, a representation of a text associated with an occupational code. The method further includes receiving, via the processor, a representation of a criterion associated with the text. The method further includes extracting, via the processor, a representation of a subset of text from the text. The method further includes, for each text from the subset of text and not for remaining text from the text, and to generate a set of candidate texts associated with the subset of text, identifying, via the processor and using a database that includes a plurality of texts, text from the plurality of texts that have semantic similarity to that text greater than a predetermined threshold. The method further includes identifying, via the processor, a subset of candidate texts from the set of candidate texts based on the criterion. The method further includes generating, via the processor and using a machine learning model, a synthetic profile associated with the text based on the subset of candidate texts. The machine learning model is trained using training data that includes a predetermined ratio of a first type of skill and a second type of skill different than the first type of skill. The predetermined ratio is predetermined based on the occupational code. The method further includes causing, via the processor, a representation of the synthetic profile to be output.

In an embodiment, an apparatus includes a memory and a processor operatively coupled to the memory. The processor is configured to receive a representation of a text. The processor is further configured to receive a representation of a criterion associated with the text. The processor is further configured to extract a representation of a subset of text from the text. The processor is further configured to, for each text from the subset of text and not for remaining text from the text, and to generate a set of candidate texts associated with the subset of text, identify, using a database that includes a plurality of texts, text from the plurality of texts that have semantic similarity to that text greater than a predetermined threshold. The processor is further configured to identify a subset of candidate texts from the set of candidate texts based on the criterion. The processor is further configured to input the subset of candidate texts to a machine learning model to generate a synthetic profile associated with the text. The machine learning model is trained using training data that includes a predetermined ratio of a first type of skill and a second type of skill different than the first type of skill. The processor is further configured to cause a representation of the synthetic profile to be output. The processor is further configured to receive indication that the synthetic profile is approved. The processor is further configured to receive a non-synthetic profile associated with the text after receiving the indication that the synthetic profile is approved. The processor is further configured to generate a hiring score for the non-synthetic profile based on the synthetic profile and the text.

In an embodiment, a non-transitory, processor-readable medium stores code representing instructions to be executed by one or more processors. The instructions comprise code to cause the one or more processors to receive a representation of a job description associated with an occupational code. The instructions further comprise code to cause the one or more processors to extract a subset of text from the job description. The subset of text includes at least one of a skill or an experience. The instructions further comprise code to cause the one or more processors to receive a representation of a criterion associated with the job description. The instructions further comprise code to cause the one or more processors to identify a set of text associated with the occupational code from a database that includes a plurality of sets of texts associated with a plurality of occupational codes. The plurality of occupational codes includes the occupational code. The instructions further comprise code to cause the one or more processors to, for each text from the subset of text and to generate a set of candidate texts associated with that subset of text, identify text from the set of text having semantic similarity to that text. The instructions further comprise code to cause the one or more processors to generate a subset of candidate texts from the set of candidate texts based on the criterion. The instructions further comprise code to cause the one or more processors to execute a machine learning model to generate a synthetic profile for the job description based on the subset of candidate texts. The machine learning model is trained using training data that includes a predetermined ratio of a first type of skill and a second type of skill different than the first type of skill. The predetermined ratio is predetermined based on the occupational code. The instructions further comprise code to cause the one or more processors to cause the synthetic profile to be output. The instructions further comprise code to cause the one or more processors to receive an indication indicating approval or disapproval of the synthetic profile.

### BRIEF DESCRIPTION OF THE DRAWINGS

FIG. 1 shows a system block diagram for generating a synthetic profile, according to an embodiment.

FIG. 2 shows a flowchart of a method to generate a synthetic profile, according to an embodiment.

FIG. 3 shows a flowchart of a method to receive a non-synthetic profile after generating a synthetic profile, according to an embodiment.

FIG. 4 shows a flowchart of a method to generate a synthetic profile and receive an indication indicating approval or disapproval of the synthetic profile, according to an embodiment.

FIG. 5 illustrates an example synthetic profile for a data scientist, according to an embodiment.

### DETAILED DESCRIPTION

Some implementations are related to iteratively generating a synthetic output using machine learning based on a user-provided input, and modifying the input until the synthetic output satisfies a predetermined set of criteria (e.g., by a user). Thereafter, the synthetic output can be used as a reference to grade non-synthetic outputs. Techniques described herein can be applied across any number of use cases, such as generating a synthetic profile of a candidate based on a job description, generating content (e.g., text, video, image, audio) based on an input command or question, and/or the like.

Some implementations are related to generating a synthetic profile based on a job description (e.g., for a job opening). For example, a recruiter (or hiring manager) can provide a job description and/or set of criteria for the job description (e.g., salary, years of experience, in-person requirement, and/or the like). Skills, experiences, and/or any other relevant attributes can be extracted from the job description, such as required degrees, languages to be fluent in, prior jobs, and/or the like. The skills, experiences, and/or attributes extracted from the job description can then be compared to text in a database to identify a semantically similar term (e.g., word or phrase). For example, if an experience is characterized by the term “programmer,” a semantically similar term can be “coder” or “software engineer.” As used herein, the term “semantically similar term” can refer to a single word that is semantically similar or a group of words (e.g., a phrase) that are semantically similar.

Thereafter, the semantically similar terms can be filtered based on the set of criteria. Filtering can include determining whether the skill, experience, and/or attribute represented by the semantically similar terms are reasonable (e.g., from the point of view of a job candidate) given the set of criteria. For example, if the semantically similar term is “Chief Engineer” but the annual salary is only $15,000, the term “Chief Engineer” can be filtered out. If, however, the semantically similar term is “good at coding” and the annual salary is $750,000, the term “good at coding” can be kept/not filtered out; that is because the skill/experience/attribute of “good at coding” is a skill a candidate applying for/hired to a job paying $750,000 a year should reasonably have.

The semantically similar terms that are retained/not filtered out can then be used/considered to generate a synthetic profile representing the profile of a fictitious job candidate that would likely apply to, be hired for, be interested in, and/or the like the job description. The recruiter can analyze the synthetic profile and determine if that type of candidate would be desirable (e.g., ideal) for the job opening. If not, the recruiter can update the job description and/or set of criteria for the job description so that a different synthetic profile is generated; this process can repeat until a synthetic profile the recruiter is satisfied with is generated.

Once a synthetic profile that recruiter is satisfied with is generated, the job description and set of criteria used to generate that synthetic profile can be used to obtain profiles of actual candidates. The synthetic profile can then be used as a point of reference (e.g., representing the ideal, best, and/or preferred candidate) to generate hiring scores for the actual candidates and/or perform a hiring action (e.g., hire the candidate, interview the candidate, reject the candidate, and/or the like).

Some techniques described herein relate to the calibration of a job description by generating synthetic profiles. Some techniques described herein improve (relative to known techniques) the experience of recruiters, speed up the hiring process, and enable job posters to have a better understanding of their job descriptions. Generating a synthetic profile can give a recruiter an instant visual of the possible candidate, making the hiring process more efficient.

Techniques described herein can generate any number of synthetic profiles for any number of job descriptions, and perform at a speed and scale that cannot practically be performed in the human mind. For example, techniques described herein can generate a synthetic profile based on a job description within seconds or milliseconds, while a human generating a synthetic profile based on a job description would take far longer (e.g., minutes to hours). Additionally known techniques would require the person (e.g., hiring manager) to be familiar with multitudes of skills and job requirements across various fields and locations, which is unrealistic. In contrast, techniques described herein enable the creation of synthetic profiles backed by, for example, millions of data points. As the number of synthetic profiles generated increases, the amount of time saved increases. Thus, considering that millions of job openings are created every year, techniques described herein can save enormous amounts of time and obtain far greater levels of productivity and throughput.

Some techniques described herein can generate a synthetic profile based on terms included in a database. The database can include terms that a hiring manager might not otherwise know or consider. The synthetic profile, as a result, can provide new and useful insights to the hiring manager that they would not otherwise receive, and thus achieve more accurate and/or desirable results not achievable by a human.

Some techniques described herein can train a machine learning model using a ratio of hard skills and filler skills that is predetermined based on the industry associated with the job description, resulting in a more complete training dataset that in turn generates a more accurate and complete machine learning model. Further, different machine learnings models can be trained for generating synthetic profiles in different industries. As a result, each machine learning model can be specially trained, through at least the use of hard skills, filler skills and predetermined ratio, in view of that model's associated industry.

Some techniques described herein include training that includes using recruiter iterative feedback. For example, a recruiter can iteratively generate synthetic profiles and learn how to update job descriptions so that those job descriptions better attract desirable candidates. Otherwise, the recruiter may fail to realize that a given job description won't attract desirable candidates until after actual candidates have begun applying. This inefficiency in the recruiting process for both recruiters and candidates can be reduced (and/or eliminated) by training models using recruiter iterative feedback as described herein.

In some implementations, a recruiter writes or uploads a job description. Skills, experiences, and other attributes are extracted from the job description. A synthetic profile is generated using the extracted skills, titles, and attributes. The synthetic profile can have a high match (e.g., be a good fit) to the job description (e.g., at least 51% similar, at least 66% similar, at least 75% similar, at least 80% similar, at least 90% similar, at least 95% similar, at least 99% similar). The synthetic profile is shown to the recruiter with options like “this profile looks like a candidate I would like to interview/hire,” “this profile doesn't look like a candidate I'd like to interview/hire,” and/or the like. If the generated profile satisfies the job description according to the recruiter, an option to score real candidates against the job description and/or against the approved synthetic profile is offered. If the generated profile does not fit the job description according to the recruiter, an option to “calibrate” the job description is offered. For example, a recruiter uploads a job description for a Warehouse Logistics Analyst and gets an intern profile as a synthetic profile; the synthetic profile does not have the intended seniority, so the recruiter adjusts the job description until a synthetic profile is generated having the correct seniority.

The synthetic profile can be generated using various techniques. For example, in some implementations, a dataset is created that contains skills, experiences, and/or other attributes suitable for/found in each standard occupational classification (SOC) (e.g., legal, medical, etc.); these skills, experiences, and/or attributes can be a compilation or summary of a large number of profiles (e.g., tens of thousands or more). Depending on where the skill, experience, and/or attribute is most seen, the skill, experience, and/or attribute is assigned a commonality score that represents uniqueness and the level of expertise desired. For example, the score can be a popularity ranking based on vector distance. A skill like “spreadsheets” (e.g., skill 1—S1) is relatively generic and might not be as rare or difficult to master as “asteroid collision monitoring” (e.g., skill 2—S2). Filters are also created based on the job description and/or data entered by a recruiter, such as salary or years of experience. Relevant skills, experiences, and/or attributes are identified based on the filters and job description. Additional filler skills and/or experiences can be added to the job description by the recruiter as well, such as filler skills like “communication” or more generic experiences. The ratio of hard skills to filler skills can be calibrated depending on the industry and/or occupational code, such as at 70/30 ratio or 80/20 ratio. The skills, experiences, and/or attributes are then used to generate text using, for example, transformer-based models. The generated text is then formatted to represent a synthetic profile having a standardized format; this can be done using a variety of languages or libraries, such as pypdf library in Python, where the resulting file (e.g., a PNG file, PDF file, a JPEG file, a DOCX file, etc.) includes a representation of the synthetic profile. Some of the elements of synthetic profile can be generated using a pre-trained transformer model or a generative artificial intelligence (AI) application programming interface (API), though this might be undesirable in some other situations because synthetic profile is industry-nuanced and full control over the training data can be desirable.

In some implementations, no personal data is used to generate the synthetic profile. In some implementations, protected classes/personal protected entities (e.g., race, gender, skin color, age, disability, pregnancy, religion, etc.) are not used for synthetic profile generation. In some implementations, the synthetic profile can highlight bias that the job description implies (e.g., if a job description features “waitress” in its text, a synthetic profile can have a warning saying “The job description is skewed to discriminate on the basis of a protected entity. Please adjust your job description.”).

In some implementations, “text” refers to written words. In some implementations, the term “text” as used herein is different than a text message (e.g., short message service (SMS)).

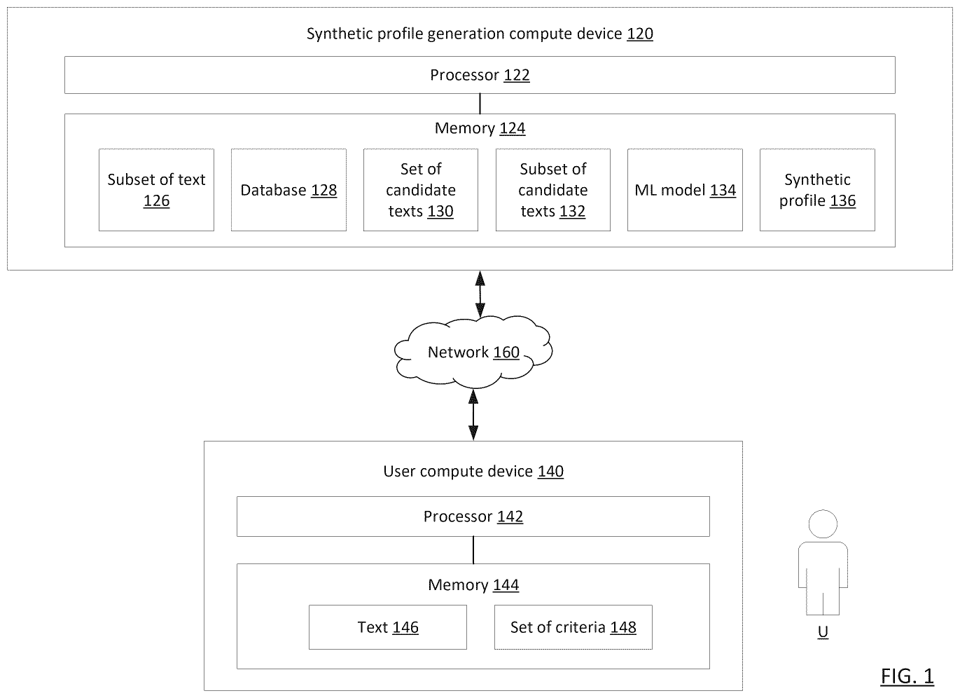

FIG. 1 shows a system block diagram for generating a synthetic profile, according to an embodiment. FIG. 1 includes synthetic profile generation compute device 120 communicatively coupled to user compute device 140 via network 160. User compute device 140 can send a signal [message] containing text (e.g., a job description) to synthetic profile generation compute device 120. In response, synthetic profile generation compute device 120 generates a synthetic profile based on the text. The synthetic profile can then be sent to user compute device 140 (e.g., for approval or disapproval by user U).

Network 160 can be any suitable communications network for transferring data, for example, operating over public and/or private communications networks. For example, network 160 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, network 160 can be a wireless network such as, for example, a Wi-Fi® or wireless local area network (“WLAN”), a wireless wide area network (“WWAN”), and/or a cellular network. In other instances, the network 160 can be a wired network such as, for example, an Ethernet network, a digital subscription line (“DSL”) network, a broadband network, and/or a fiber-optic network. In some instances, network 160 can use Application Programming Interfaces (APIs) and/or data interchange formats, (e.g., Representational State Transfer (REST), JavaScript Object Notation (JSON), Extensible Markup Language (XML), Simple Object Access Protocol (SOAP), and/or Java Message Service (JMS)). The communications sent via network 160 can be encrypted or unencrypted. In some instances, the network 160 can include multiple networks or subnetworks operatively coupled to one another by, for example, network bridges, routers, switches, gateways and/or the like.

Synthetic profile generation compute device 120 and user compute device 140 can each be any type of compute device, such as a server, desktop, laptop, tablet, mobile device, smart device, internet-of-things (IoT) device, and/or the like. User compute device 140 is associated with (e.g., accessible by, being used by, owned by, has an account in the name of, etc.) user U. User U can be any type of user, such as a recruiter, job candidate, manager, and/or the like.

Synthetic profile generation compute device 120 includes processor 122 operatively coupled to memory 124 (e.g., via a system bus). User compute device 140 includes processor 142 operatively coupled to memory 144 (e.g., via a system bus). Synthetic profile generation compute device 120 and user compute device 140 can be remote (e.g., separate computers and at different locations) from one another.

Processor 122 and/or 142 can be, for example, a hardware-based integrated circuit (IC) or any other suitable processing device configured to run and/or execute a set of instructions or code. For example, processor 122 and/or 142 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, processor 122 and/or 142 can be configured to run any of the methods and/or portions of methods discussed herein.

Memory 124 and/or 144 can be, for example, a random-access memory (RAM), a memory buffer, a hard drive, a read-only memory (ROM), an erasable programmable read-only memory (EPROM), and/or the like. Memory 124 and/or 144 can be configured to store any data used by the processors to perform the techniques (methods, processes, etc.) discussed herein. In some instances, memory 124 and/or 144 can store, for example, one or more software programs and/or code that can include instructions to cause processors 122 and/or 142 to perform one or more processes, functions, and/or the like. In some implementations, memory 124 and/or 144 can include extendible storage units that can be added and used incrementally. In some implementations, memory 124 and/or 144 can be a portable memory (for example, a flash drive, a portable hard disk, and/or the like) that can be operatively coupled to the processors. In some instances, memory 124 and/or 144 can be remotely operatively coupled with a compute device (not shown in FIG. 1).

Memory 144 of user compute device 140 can include (e.g., store) text 146. Text 146 can represent, for example, a job description for a job opening. Text 146 can be generated based on input from user U. Text 146 can include details regarding the job description, such as the company hiring for the job description, details about the company, a job title, a job purpose, job duties and responsibilities, required qualification, preferred qualifications, working conditions, location of the job, salary, and/or the like.

Text 146 can be associated with an occupational code (e.g., standard occupational classification code). Occupational codes can represent a statistical standard used (e.g., by a government) to classify workers into job-related categories (e.g., management occupations, business and financial operations occupations, computer and mathematical occupations, legal occupations, protective service occupations, production occupations, etc.). The occupational code associated with text 146 indicates the job-related category for the job opening that a hiring entity is hiring for using text 146. For example, if text 146 is a job description for a tax lawyer, the occupational code associated with text 146 can be the “legal occupations” occupational code. In some implementations, the occupational code is provided by user U. In some implementations, the occupational code is determined by inputting text 146 into a machine learning model (e.g., and without user intervention); for example, the machine learning model can be a neural network trained to output occupational codes using various texts (e.g., job descriptions) as input learning data and associated occupational codes as target/output learning data. The machine learning model could be located at user compute device 140, synthetic profile generation compute device 120, a compute device not shown in FIG. 1, and/or the like.

Memory 144 of user compute device 140 can also include (e.g., store) set of criteria 148, which can include one or more criteria associated with text 146 (e.g., from an employer/hiring entity's perspective). Where text 146 is a job description for a job opening, set of criteria 148 can indicate preferred and/or required criteria that an employer/hiring entity wants from a candidate applying to the job opening. Examples of criteria that could be included in set of criteria 148 include a salary/salary range for the job opening; whether the work is fully in-person, hybrid, or fully remote; a required or preferred number of years of experience; a required or preferred education; a required or preferred job title; a required or preferred technical skill; a required or preferred language experience/skill; a location of the job site; and/or the like. Set of criteria 148 can include at least on criterion.

In some implementations, set of criteria 148 is generated based on text 146. For example, a machine learning model (e.g., different than the machine learning model used to output occupational codes or the same as the machine learning model used to output occupational codes) can receive text 146 and generate set of criteria 148 based on text 146. The machine learning model could be located at user compute device 140, synthetic profile generation compute device 120, a compute device not shown in FIG. 1, and/or the like. The machine learning model can be, for example, a neural network trained using job descriptions as input learning data and criteria extracted from those job descriptions as target learning data. Additionally or alternatively, in some implementations, set of criteria 148 includes information not included in text 146. For example, user U can provide indication of a criterion not included in text 146 to be part of set of criteria 148 (e.g., if user U does not want that criteria to be made public within text 146).

Text 146 and set of criteria 148 can be sent from user compute device 140 to synthetic profile generation compute device 120 via network 160. For example, user compute device 140 can generate and send a [message] containing text 146 and set of criteria 148 to synthetic profile generation compute device 120 via network 160. In some implementations, text 146 and set of criteria 148 are encrypted by user compute device 140 and sent to synthetic profile generation compute device 120, which can increase data security and be particularly desirable where data is being exchanged over network 160 instead of being processed locally on a single device or over an internal network owned/controlled by an entity that also owns/controls synthetic profile generation compute device 120 and user compute device 120.

Memory 124 of synthetic profile generation compute device 120 can include (e.g., store) subset of text 126. Subset of text 126 can be generated at synthetic profile generation compute device 120 in response to synthetic profile generation compute device 120 receiving representations of text 146 and/or set of criteria 148 (e.g., automatically and without human intervention). In some implementations, subset of text 126 is generated based on (e.g., extracted from) text 146 and/or set of criteria 148. Subset of text 126 can represent skills, experiences, and/or other attributes included in text 146 and/or set of criteria 148. Subset of text 126 can indicate skills, experiences, and/or attributes that text 146 indicates as preferred and/or required (e.g., by the hiring employer) for the job opening. For example, if text 146 includes a hiring company's name, the company's history, the required technical skills, and the required education level, information that the hiring company would want to know about a candidate would likely include their technical skills and education level; thus, the technical skills and education level indicated by text 146 can be included in subset of text 126, but other details from text 146 that the hiring company would not need or want to know when evaluating a candidate (e.g., hiring company's name and history) can be omitted from subset of text 126. Additionally or alternatively, at least a portion of set of criteria 148 can be used as subset of text 126. Thus, subset of text 126 can be different from or the same as set of criteria 148.

In some implementations, a “skill” refers to abilities that a candidate brings or possesses, whether that candidate has been formally educated in them or not. In some implementations, an “experience” refers to knowledge that a candidate has acquired through its work history, school history, and/or the like. In some implementations, “attributes” refers to any other information (any other information that is not a skill or experience) that a hiring entity would want to know about a candidate when deciding whether to interview, hire, and/or otherwise pursue a candidate, such as awards, certifications, and/or the like. Together, a list of skills, experiences, and/or attributes for a candidate can include information about the candidate that a hiring entity would want to know about the candidate when deciding whether to interview, hire, and/or otherwise pursue a candidate. Other information about a candidate that a hiring entity would not need to know about when deciding whether to interview, hire, and/or otherwise pursue a candidate, however, would not be a skill, experience, and/or attribute extracted from text 146 and/or set of criteria 148 into subset of text 126. In some implementations, what is considered a skill, experience, and/or attribute is predetermined by a user and/or software. For example, a user can provide a list or table that indicates all or at least some terms that are to be considered a skill, terms that are to be considered an experience, and terms that are to be considered attributes.

Memory 124 of synthetic profile generation compute device 120 can include (e.g., store) database 128. Database 128 can include a plurality of texts (e.g., textual data; not a text message/short message service (SMS)) including skills, experiences, and/or attributes organized according to occupational codes. Said differently, for each occupational code from a plurality of occupational codes, database 128 can include a list of texts representing skills, experiences, and/or attributes associated with (e.g., provided by a user and/or included in prior resumes, profiles, or cover letters for jobs also associated with) that occupational code. For example, database 128 can include skills, experiences, and/or attributes associated with the management occupational code; skills, experiences, and/or attributes associated with the business and financial operations occupational code; skills, experiences, and/or attributes associated with the computer and mathematical occupational code; skills, experiences, and/or attributes associated with the legal occupational code; skills, experiences, and/or attributes associated with the protective service occupational code; and/or the like. The data stored within database 128 can be created by, for example, analyzing candidate application materials (e.g., resumes, cover letters, profiles, letters of recommendation, etc.) for jobs, and including the skills, experiences, and/or attributes extracted from those materials in a bucket representing the occupational code that job is part of. Database 128 can be any type of database, such as a hierarchical database, relational database, non-relational database, object-oriented database, and/or the like.

Database 128 can also include an indication of, for each skill, experience, and/or attribute associated with an occupational code, a commonality score (e.g., in a range between 0 being least common and 1 being most common) indicating how common that skill, experience, and/or attribute is (e.g., for that occupational code, across all occupational codes in database 128, across a predetermined subset of occupational codes in database 128). For example, for the skills, experiences, and/or attributes associated with the legal occupation code, database 128 can indicate that skills, experiences, and/or attributes such as “law school” or “reading” are more common in the legal occupation, while skills, experiences, and/or attributes such as “former chef” or “assembly language” are less common in the legal occupation. On the other hand, for the skills, experiences, and/or attributes associated with the food preparation and serving related occupations code, database 128 can indicate that skills, experiences, and/or attributes such as “law school” are less common in the food preparation and serving related occupation, while skills, experiences, and/or attributes such as “former chef” are more common the food preparation and serving related occupation. Commonality can be determined based on, for example, external data indicating how common certain skills, experiences, and/or attributes are and/or by tallying how many times a given skill, experience, and/or attribute was included in received candidate profiles.

Memory 124 of synthetic profile generation compute device 120 can include (e.g., store) set of candidate texts 130. Set of candidate texts 130 can be text that might be used to generate a synthetic profile; said differently, some text in set of candidate texts 130 might be used to generate the synthetic profile, while some text in set of candidate texts 130 might not be used to generate the synthetic profile. Set of candidate texts 130 can be generated at synthetic profile generation compute device 120 by identifying, for each text in subset of text 126, text from database 128 that is (1) associated with the same occupational code as text 146 (e.g., and not text from database 128 associated with different occupational codes) and (2) has a semantic similarity (e.g., determined based on Manhattan Distance, Euclidean Distance, Cosine Similarity, Jaccard Index, and Sorensen-Dice Index) to that text above a predetermined acceptable threshold (e.g., at least 50% semantically similar, at least 66% semantically similar, at least 75% semantically similar, at least 90% semantically similar, at least 99% semantically similar, and/or the like). For example, if text 146 represents a job description for a “patent attorney,” text 146 is associated with the legal occupations occupational code, and subset of text 126 includes “software programming,” all text (representing skills, experiences, and/or attributes) in database 128 associated with (e.g., categorized within) the legal occupations occupational code can be compared to the term “software programming” for semantic similarity; in such an example, terms such as “software engineer” or “front-end developer” are more likely to be included in set of candidate texts 130 than terms like “tax lawyer” or “law clerk.”

Set of candidate texts 130 can be generated by analyzing a portion of the data in database 128, but not all data in database 128. For example, where text 146 is a job description for a job categorized in an occupational code, then skills, experiences, and/or attributes in database 128 associated with (e.g., categorized within) other occupational codes are not analyzed (e.g., for semantic similarity) to generate set of candidate texts 130. By limiting the amount of data to be analyzed, synthetic profile generation compute device 120 can generate set of candidate texts 130 faster and with less processing burden.

Memory 124 of synthetic profile generation compute device 120 can include (e.g., store) subset of candidate texts 132. Subset of candidate texts 132 can include a subset of text from set of candidate texts 130 that are candidates for being used to generate a synthetic profile. Subset of candidate texts 132 can be generated based on set of candidate texts 130 and set of criteria 148. For example, set of criteria 148 can include a representation of, for each criterion, a desirability score indicating a desirability for that criterion (e.g., from the perspective of a job candidate and not the employer); the desirability score can be generated based on historical data, input from user U, feedback from prior candidates and/or current employees, and/or the like. The desirability score(s) of set of criteria 148 can be compared against the commonality score associated with each candidate text from subset of candidate texts 132 to determine if the desirability is reasonable and/or appropriate for that candidate text (e.g., if the difference between the desirability score and commonality score are within a predetermined acceptable range). The lower the desirability score(s) is, the less likely that candidates having skills, experiences, and/or attributes associated with lower commonality scores (e.g., skills, experiences, and/or attributes that are less common) will apply to text 146 (and vice versa—the higher the desirability score(s) is, the more likely that candidates having skills, experiences, and/or attributes associated with lower commonality scores will apply to text 146). For example, if set of criteria 148 for a job opening has a higher desirability score (e.g., the annual salary is $750,000 and at least one year of experience is preferred), the more likely that a candidate with skills, experiences, and/or attributes with low commonality scores (e.g., chief engineer at a high visibility company, highly-ranked law school valedictorian, etc.) apply for that job opening. If, however, set of criteria 148 for the job opening has a lower desirability score (e.g., the annual salary is $25,000 and at least fifteen years of experience are required), the less likely that a candidate with skills, experiences, and/or attributes with low commonality scores (e.g., chief engineer, highly-ranked law school graduate, etc.) apply for that job opening.

Memory 124 of synthetic profile generation compute device 120 can include (e.g., store) machine learning (ML) model 134. ML model 134 can be configured to generate synthetic profiles based on subsets of candidate text. ML model 134 can be any type of ML model. In some implementations, ML model 134 is a transformer ML model, which can handle larger input sequences and be more accurate compared to other types of ML models.

In some implementations, ML model 134 is trained using training data that includes hard skills and filler skills. In some implementations, “hard skills” refer to job-related expertise and abilities that are crucial (e.g., necessary, must-have) to complete the work, while “filler skills” refer to personal qualities and traits that impact work but might not be crucial to complete the work (e.g., soft skills). In some implementations, hard skills are often applicable to a certain career, while filler skills are often transferrable across many/most careers. Hard skills can include, for example, Microsoft Office® expertise, interpreting data, financial planning, copywriting, troubleshooting, project management, spoken languages, and/or the like, while filler skills can include, for example, communication skills, timekeeping, critical thinking, leadership skills, motivation, ambition, negotiating, and/or the like. Filler skills can but do not have to be included in text 146; for example, in some implementations, filler skills are not included in text 146 but are skills common in the industry and/or common for a given set of hard skills.

In some implementations, the skills that are considered hard skills and/or filler skills are predetermined (e.g., by a user and/or by software). Thus, a representation, such as a list or table, can be generated that indicates those skills that are hard skills and those skills that are filler skills. For example, a user can predetermine and provide a representation of (e.g., in the form of a list or table) those skills that should be considered hard skills and those skills that should be considered filler skills. As another example, software can predetermine and provide a representation of (e.g., in the form of a list or table) those skills that should be considered hard skills and those skills should be considered filler skills. As another example, software can predetermine and provide an initial representation of those skills that should be considered hard skills and those skills that should be considered filler skills, and a human can review and edit the initial representation as needed (or desired).

In some implementations, ML model 134 is trained using training data that includes a predetermined ratio of a first type of skill (e.g., hard skills, non-filler skills) and a second type of skill different than the first type of skill (e.g., filler skills, soft skills). For example, ML model 134 can be trained using input data that includes the predetermined ratio of hard skills and filler skills (e.g., the training data is 50% hard skills and 50% filler skills, the training data is 60% hard skills and 40% filler skills, the training data is 70% hard skills and 30% filler skills, the training data is 80% hard skills and 20% filler skills, and/or the like), and synthetic profiles as output/target learning data. By doing so, ML model 134 can be configured to generate synthetic profiles including hard skills and/or soft skills. In some implementations, the generated synthetic profiles can also include a substantially (e.g., within 1%, within 5%, within 10%, within 25%, and/or the like) similar ratio of the first type of skill to the second type of skill as was used to train the ML model(s) that generated the synthetic profiles. Additionally or alternatively, in some implementations, the job descriptions used to generate the synthetic profiles can include a substantially (e.g., within 1%, within 5%, within 10%, within 25%, and/or the like) similar ratio of the first type of skill to the second type of skill as was used to train ML model 134. In some implementations, ML model 134 is trained at synthetic profile generation compute device 120. In some implementations, ML model 134 is trained at a device other than synthetic profile generation compute device 120, and sent to/received by synthetic profile generation compute device 120.

Memory 124 of synthetic profile generation compute device 120 can include (e.g., store) synthetic profile 136. Synthetic profile 136 can be generated by inputting subset of candidate texts 132 to ML model 134. Synthetic profile 136 can represent the profile of a job candidate that is likely to apply for, be interested in, and/or be hired for the job opening associated with text 146 given set of criteria 148. Synthetic profile 136 can include representations of skills, experiences, and/or attributes, such as text from subset of candidate texts 132. Synthetic profile 136 can include hard skills but not filler skills, filler skills but not hard skills, or a combination of hard skills and filler skills. In some implementations, synthetic profile 136 is in pdf format.

In some implementations, synthetic profile 136 can (but does not have to) be generated by inputting subset of candidate texts 132, but not set of candidate texts 130, subset of text 126, and/or text 146, to ML model 134. By limiting the amount of input provided to ML model 134, ML model 134 can process less data and thus generate synthetic profile 136 faster.

In response to generating synthetic profile 136, a representation of synthetic profile 136 can be sent from synthetic profile generation compute device 120 to user compute device 140. In response to receiving a representation of synthetic profile 136, user compute device 140 can output (e.g., display) synthetic profile 136. User U can analyze synthetic profile 136, and determine if such hypothetical person would be desirable for the job opening associated with text 146 given set of criteria 148.

If user U determines that synthetic profile 136 would not be desirable for the job opening associated with text 146, user U can update text 146 and/or set of criteria 148. The updated text and/or set of criteria can then be used to generate an additional synthetic profile for user U's consideration. For example, user U can update only text 146, only set of criteria 148, or both text 146 and set of criteria 148, to generate a different synthetic profile. Such an iterative process of updating text 146 and/or set of criteria 148 and generating a synthetic profile can occur until user U determines that the generated synthetic profile would be desirable/acceptable for the job opening. As a result, a job description and/or set of criteria is eventually produced that is more likely to attract preferred/ideal candidates.

In response to user U determining that synthetic profile 136 (or a subsequently generated synthetic profile) would be desirable/acceptable for the job opening associated with text 146 (or a subsequently generated job description), text 146 (or the subsequently generated job description) can be used to attract actual job candidates. For example, text 146 can be posted to one or more hiring sources so that actual job candidates can apply. In response to receiving job profiles of actual job candidates, synthetic profile 136 can be used to generate hiring scores for the received job profiles of actual job candidates. For example, synthetic profile 136 can represent the “ideal” or “preferred” job candidate, and can be used as a reference point to determine how close to ideal or preferred the actual job candidates are (e.g., the closer to ideal or preferred a job candidate is, the higher/better the hiring score). Additionally or alternatively, in response to receiving job profiles of actual job candidates, synthetic profile generation compute device 120 and/or user compute device 140 can perform a hiring action, such as flagging a candidate for further review, contacting a candidate to schedule an interview, performing a background check on the candidate, contacting a reference provided by the candidate, requesting additional documentation from a candidate, removing a candidate from consideration of a job opening, contacting a candidate to notify him that he's been hired or not hired, and/or the like.

In some implementations, user compute device 140 receives from user U (1) an indication that a synthetic profile 136 is not approved and (2) a reason for the disapproval (e.g., lacking certain technical skills, not located in a particular region, not enough year of relevant experience, etc.). In response, text 146 can be updated based on (e.g., to accommodate) the reason. Additionally or alternatively, reasons can be provided to user U why the reason for disapproval is unrealistic given text 146 and/or set of criteria 148 (e.g., the salary is too low, too many years of experience required, the job location is undesirable, etc.). For example, if user U indicates that synthetic profile 136 is disapproved because the hypothetical job candidate represented by synthetic profile 136 does not have enough years of experience, text 146 can be updated to indicate that a higher number of years of experience is desired and/or recommend to user U that at least one criteria from set of criteria 148 should be updated to attract candidates having that number of years of experience (e.g., increase salary, provide certain benefits, etc.).

In some implementations, ML model 134 is trained using training data that is specific to an occupational code, and receives text from job descriptions associated with that same occupational code. Thus, where database 128 includes text for multiple occupational codes, multiple ML models can be trained; the ML model associated with the same occupational code as a given job description can be used to generate a synthetic profile. For example, a first ML model can be trained using training data associated with a first occupational code and, after training, generate synthetic profiles based on job descriptions associated with the first occupational code; additionally, a second ML model can be trained using training data associated with a second occupational code (different than the first occupational code) and, after training, generate synthetic profiles based on job descriptions associated with the second occupational code. By using ML models trained using data associated with a specific occupational code, the ML model can produce more accurate and fine-tuned results.

In some implementations, the training data for an occupational code that is used to train a given ML model has a predetermined ratio of hard skills to filler skills based on the occupational code. For example, for an ML model that is configured to generate synthetic profiles based on job descriptions for legal occupations, the training data used to train the ML model can include a predetermined ratio of hard skills and filler skills that is determined in view of the legal occupation (e.g., 80% hard skills and 20% filler skills). For a second ML model that is configured to generate synthetic profiles based on job descriptions for food preparation occupations, however, the training data used to train the second ML model can include a different predetermined ratio of hard skills and filler skills that is determined in view of the food preparation occupation (e.g., 70% hard skills and 30% filler skills).

In some implementations, training ML model 134 includes a feedback loop. For example, during training, errors (e.g., wrong format, wrong data, wrong ratio of hard skills compared to filler skills, includes personal information, is biased or discriminatory, etc.) made in the output (e.g., synthetic profile) produced by ML model 134 can be fed back into ML model 134 as input, allowing ML model 134 to avoid similar errors in the future. The errors can be identified by, for example, a user and/or an additional model configured to detect such errors.

In some implementations, synthetic profile generation compute device 120 and/or user compute device 140 can determine whether text 146 and/or synthetic profile 136 includes terms associated with (e.g., having) bias. In some implementations, a term associated with bias can refer to a term that is biased in favor of one class (e.g., a protected class or unprotected class) at the expense of another class (e.g., a protected class). What counts as a term associated with bias can be based on, for example, a predetermined list of terms designated as terms associated with bias, user U input, a machine learning model trained to detect terms associated with bias, and/or the like. In response to determining that a term is associated with bias, text 146 and/or synthetic profile 136 can be updated (e.g., automatically and without human intervention; in response to confirmation by user U). As an example, if text 146 uses “waitress,” synthetic profile generation compute device 120 and/or user compute device 140 can produce an output to the effect of “The term ‘waitress’ is biased” or “The job description is skewed to discriminate on the basis of a protected entity. Please adjust your job description.”

Although FIG. 1 illustrates only synthetic profile generation compute device 120 and user compute device 140, in some implementations, more or less compute devices can be used. For example, a single compute device can perform the functionalities of both synthetic profile generation compute device 120 and user compute device 140. As another example, the functionalities of synthetic profile generation compute device 120 can be divided amongst a first compute device configured to store database 128 and a second compute device configured to generate synthetic profile 136, etc.

Any number of synthetic profiles can be generated for any number of job descriptions and sets of criteria. Further, any number of user compute devices can request synthetic profiles. For example, synthetic profile generation compute device 120 can generate a first synthetic profile based on a first job description and/or first set of criteria provided by a first user compute device, generate a second synthetic profile based on a second job description and/or second set of criteria provided by the first user compute device, generate a third synthetic profile based on a third job description and/or third set of criteria provided by a second user compute device (different than the first user compute device), and/or the like.

In some implementations, any of the training data mentioned herein (e.g., filler skills, hard skills, occupational codes, job descriptions, synthetic profiles, etc.) can be augmented to generate an updated training data. For example, training data can be augmented to include synonyms, include antonyms, include additional text, remove text, be in different formats, and/or the like. The updated training data can be larger and/or have more variety than the initial training data, which can result in the associated ML model being trained using the updated training data being more accurate and reliable.

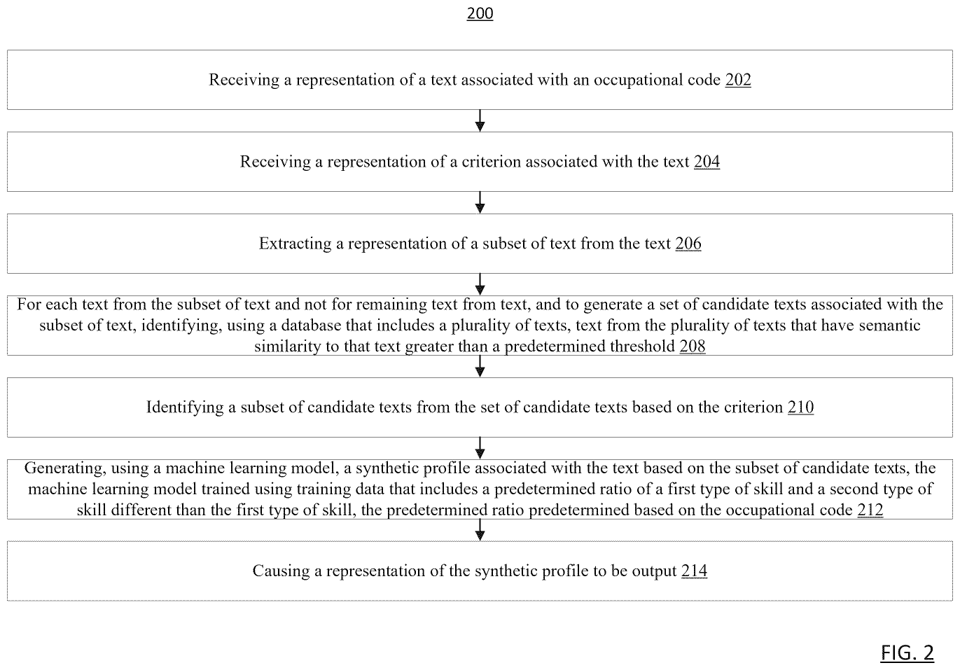

FIG. 2 shows a flowchart of a method 200 to generate a synthetic profile, according to an embodiment. In some implementations, method 200 is performed by a processor (e.g., processor 122).

At 202, a representation of a text (e.g., text 146) associated with an occupational code is received. For example, with reference to FIG. 1, an electronic signal including a representation of text 146 is received at synthetic profile generation compute device 120 from user compute device 140 via network 160.

At 204, a representation of a criterion (e.g., included in set of criteria 148) associated with the text is received. For example, with reference to FIG. 1, an electronic signal including a representation of set of criteria 148 is received at synthetic profile generation compute device 120 from user compute device 140 via network 160. In some implementations, 204 can occur before 202, in parallel with 202, and/or automatically (e.g., without human intervention) in response to completing 202.

At 206, a representation of a subset of text (e.g., subset of text 126) is extracted from the text. In some implementations, 206 occurs automatically (e.g., without human intervention) in response to completing 202 and/or 204. In some implementations, 206 can occur before 204.

At 208, for each text from the subset of text and not for remaining text from the text, and to generate a set of candidate texts (e.g., set of candidate texts 130) associated with the subset of text, text from a plurality of texts (e.g., skills, experiences, attributes, etc.) that have semantic similarity to that text greater than a predetermined threshold is identified using a database (e.g., database 128) that includes the plurality of texts. In some implementations, 208 occurs automatically (e.g., without human intervention) in response to completing 206. In some implementations, 208 can occur before 204.

At 210, a subset of candidate texts (e.g., subset of candidate texts 132) from the set of candidate texts is identified based on the criterion. In some implementations, 210 occurs automatically (e.g., without human intervention) in response to completing 208 and 204.

At 212, a synthetic profile associated with the text is generated using a machine learning model (e.g., ML model 134) and based on the subset of candidate texts. The machine learning model is trained using training data that includes a predetermined ratio of a first type of skill (e.g., hard skill, non-filler skill) and a second type of skill different than the first type of skill (e.g., filler skill, soft skill). The predetermined ratio is predetermined based on the occupational code. In some implementations, 212 occurs automatically (e.g., without human intervention) in response to completing 210.

At 214, a representation of the synthetic profile is caused to be output. With reference to FIG. 1, 214 could include, for example, sending an electronic signal representing the synthetic profile from synthetic profile generation compute device 120 to user compute device 140, where user compute device 140 is configured to output the synthetic profile in response to receiving the electronic signal. In some implementations, 214 occurs automatically (e.g., without human intervention) in response to completing 212.

In some implementations of method 200, the text is a first text, the subset of text is a first subset of text, the set of candidate texts is a first set of candidate texts, the subset of candidate texts is a first subset of candidate texts, and the synthetic profile is a first synthetic profile. Method 200 can further include receiving, after the first synthetic profile is caused to be output at 214, a representation of a second text different than the first text. Method 200 can further include extracting a representation of a second subset of text from the second text. Method 200 can further include, for each text from the second subset of text and not for remaining text from the second text, and to generate a second set of candidate texts associated with the second subset of text and different than the first set of candidate texts, identifying, using the database, text from the plurality of texts that have semantic similarity to that text greater than the predetermined threshold. Method 200 can further include identifying a second subset of candidate texts from the second set of candidate texts based on the criterion. Method 200 can further include generating a second synthetic profile associated with the second text based on the second subset of candidate texts. Method 200 can further include causing a representation of the second synthetic profile to be output (e.g., at user compute device 140 and/or a compute device not shown in FIG. 1).

In some implementations of method 200, the text is a first text, the criterion is a first criterion, the subset of text is a first subset of text, the set of candidate texts is a first set of candidate texts, the subset of candidate texts is a first subset of candidate texts, and the synthetic profile is a first synthetic profile. Method 200 can further include receiving, after the first synthetic profile is caused to be output, a representation of a second text different than the first text. Method 200 can further include receiving a representation of a second criterion that is associated with the text and different than the first criterion. Method 200 can further include extracting a representation of a second subset of text from the second text. Method 200 can further include, for each text from the second subset of text and not for remaining text from the second text, and to generate a second set of candidate texts associated with the second subset of text and different than the first set of candidate texts, identifying, using the database, text from the plurality of texts that have semantic similarity to that text greater than the predetermined threshold. Method 200 can further include identifying a second subset of candidate texts from the second set of candidate texts based on the second criterion. Method 200 can further include generating a second synthetic profile associated with the second text based on the second subset of candidate texts. Method 200 can further include causing a representation of the second synthetic profile to be output (e.g., at user compute device 140 and/or a compute device not shown in FIG. 1).

In some implementations of method 200, the criterion is a first criterion, the subset of candidate texts is a first subset of candidate texts, and the synthetic profile is a first synthetic profile. Method 200 can further include receiving, after the first synthetic profile is caused to be output at 314, a representation of a second criterion that is associated with the text and different than the first criterion. Method 200 can further include identifying a second subset of candidate texts from the set of candidate texts based on the second criterion and not the first criterion. Method 200 can further include generating a second synthetic profile associated with the text based on the second subset of candidate texts and not the first subset of candidate texts. Method 200 can further include causing a representation of the second synthetic profile to be output (e.g., at user compute device 140 and/or a compute device not shown in FIG. 1).

In some implementations of method 200, the plurality of texts is a first plurality of texts associated with the occupational code, the occupational code is from a plurality of occupational codes, and the database further includes texts not associated with the occupational code. Method 200 further includes refraining from determining semantic similarity between (1) text from the texts not associated with the occupational code and (2) text from the subset of text; refraining could include sending an electronic signal representing instructions to not determine semantic similarity between (1) text from the texts not associated with the occupational code and (2) text from the subset of text and/or not sending an electronic signal representing instructions to determine semantic similarity between (1) text from the texts not associated with the occupational code and (2) text from the subset of text.

In some implementations of method 200, each candidate text from the set of candidate texts is associated with a commonality score from a plurality of commonality scores, and identifying the subset of candidate texts from the set of candidate texts at 210 includes determining a desirability score associated with the criterion and, for each candidate text from the set of candidate texts, determining whether that candidate text should be included in the subset of candidate texts based on a comparison between the commonality score from the plurality of commonality scores associated with that candidate text and the desirability score.

In some implementations of method 200, the text is a job description, the criterion is one of a salary, benefit (e.g., medical coverage, paid time off, maternity leave, student loan repayment, etc.), or years of experience, and the subset of text includes at least one of a skill or an experience.

Some implementations of method 200 further include receiving an indication that the synthetic profile is approved. Some implementations of method 200 further include causing, in response to receiving the indication that the synthetic profile is approved, the text to be accessible by a plurality of candidates (e.g., posted on a job board). Some implementations of method 200 further include receiving, in response to the text being accessible by the plurality of candidates, a plurality of candidate profiles associated with the plurality of candidates. Some implementations of method 200 further include causing a hiring action associated with the text based on the plurality of candidate profiles.

Some implementations of method 200 further include determining, for each text from the subset of text, whether that text is associated with bias. Some implementations of method 200 further include, for each text from the subset of text associated with bias, outputting an indication that that text is associated with bias.

In some implementations of method 200, the machine learning model is a transformer machine learning model.

In some implementations of method 200, receiving the representation of the criterion associated with the text at 204 includes extracting, without human intervention, the criterion from the text.

Some implementations of method 200 further include receiving an indication that the synthetic profile is disapproved. Some implementations of method 200 further include receiving an indication of a reason for disapproval of the synthetic profile. Some implementations of method 200 further include updating, in response to receiving the reason, the text based on the reason.

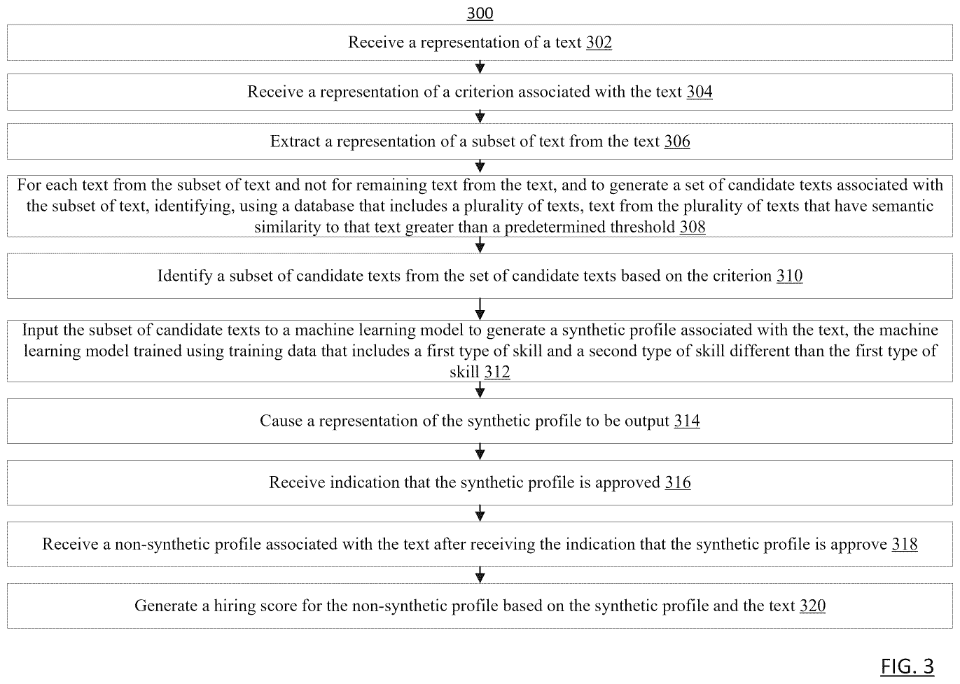

FIG. 3 shows a flowchart of a method 300 receive a non-synthetic profile after generating a synthetic profile, according to an embodiment. In some implementations, method 300 is performed by a processor (e.g., processor 122).

At 302, a representation of a text (e.g., text 146) is received. For example, with reference to FIG. 1, an electronic signal including a representation of text 146 is received at synthetic profile generation compute device 120 from user compute device 140 via network 160.

At 304, a representation of a criterion (e.g., included in set of criteria 148) associated with the text is received. For example, with reference to FIG. 1, an electronic signal including a representation of set of criteria 148 is received at synthetic profile generation compute device 120 from user compute device 140 via network 160. In some implementations, 304 can occur before 302, in parallel with 302, and/or automatically (e.g., without human intervention) in response to completing 302.

At 306, a representation of a subset of text (e.g., subset of text 126) is extracted from the text. In some implementations, 306 occurs automatically (e.g., without human intervention) in response to completing 302 and/or 304. In some implementations, 306 can occur before 304.

At 308, for each text from the subset of text and not for remaining text from the text, and to generate a set of candidate texts (e.g., set of candidate texts 130) associated with the subset of text, text from a plurality of texts included in a database (e.g., database 128) that have semantic similarity to that text greater than a predetermined threshold are identified. In some implementations, 308 occurs automatically (e.g., without human intervention) in response to completing 306. In some implementations, 308 can occur before 304.

At 310, a subset of candidate texts (e.g., subset of candidate texts 132) is identified from the set of candidate texts based on the criterion. In some implementations, 310 occurs automatically (e.g., without human intervention) in response to completing 308 and 304.

At 312, the subset of candidate texts is input to a machine learning model (e.g., ML model 134) to generate a synthetic profile (e.g., 136) associated with the text. The machine learning model is trained using training data that includes a predetermined ratio of a first type of skill (e.g., hard skill, non-filler skill) and a second type of skill different than the first type of skill (e.g., filler skill, soft skill). In some implementations, 312 occurs automatically (e.g., without human intervention) in response to completing 310.

At 314, a representation of the synthetic profile is caused to be output. With reference to FIG. 1, 314 could include, for example, sending an electronic signal representing the synthetic profile from synthetic profile generation compute device 120 to user compute device 140, where user compute device 140 is configured to output the synthetic profile in response to receiving the electronic signal. In some implementations, 314 occurs automatically (e.g., without human intervention) in response to completing 312.

At 316, an indication is received that the synthetic profile is approved. With reference to FIG. 1, 316 could include, for example, synthetic profile generation compute device 120 receiving an electronic signal from user compute device 140 indicating that the synthetic profile has been approved (e.g., by user U).

At 318, a non-synthetic profile associated with the text is received after receiving the indication that the synthetic profile is approved. The non-synthetic profile could be, for example, an actual profile generated by an actual candidate applying for the text (e.g., job description). The non-synthetic profile could be received from any compute device, such as user compute device 140 in FIG. 1, a compute device of the actual candidate applying for the text, a compute device associated with a site where the text is posted (e.g., a job board), and/or the like. In some implementations, there is human intervention between 316 and 318 (e.g., a candidate applying for a job opening).

At 320, a hiring score is generated for the non-synthetic profile based on the synthetic profile and the text. The hiring score can indicate, for example, how appealing the candidate represented by the non-synthetic profile is for a hiring entity (e.g., user U) and/or how similar the non-synthetic profile is to the synthetic profile. In some implementations, 320 occurs automatically (e.g., without user intervention) in response to completing 318.

In some implementations of method 300, the text is associated with an occupational code, the plurality of texts is associated with the occupational code, and the predetermined ratio is predetermined based on the occupational code.

In some implementations of method 300, the machine learning model is a transformer machine learning model.

In some implementations of method 300, each candidate text from the set of candidate texts is associated with a commonality score from a plurality of commonality scores, and identifying the subset of candidate texts from the set of candidate texts at 310 includes determining a desirability score associated with the criterion and, for each candidate text from the set of candidate texts, determining whether that candidate text should be included in the subset of candidate texts based on a comparison between the commonality score from the plurality of commonality scores associated with the candidate text and the desirability score.

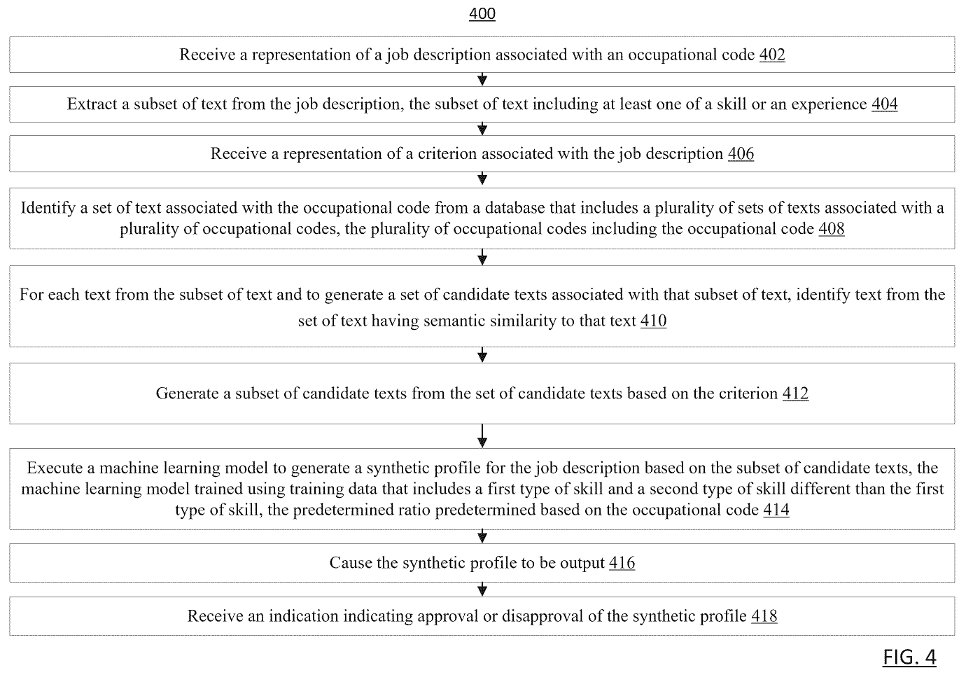

FIG. 4 shows a flowchart of a method 400 to generate a synthetic profile and receive an indication indicating approval or disapproval of the synthetic profile, according to an embodiment. In some implementations, method 400 is performed by a processor (e.g., processor 122).

At 402, a representation of a job description (e.g., text 146) associated with an occupational code is received. For example, with reference to FIG. 1, an electronic signal including a representation of text 146 is received at synthetic profile generation compute device 120 from user compute device 140 via network 160.

At 404, a subset of text (e.g., subset of text 126) is extracted from the job description. The subset of text includes at least one of a skill or an experience. In some implementations, 404 occurs automatically (e.g., without human intervention) in response to completing 402.

At 406, a representation of a criterion (e.g., included in set of criteria 148) associated with the job description is received. For example, with reference to FIG. 1, an electronic signal including a representation of set of criteria 148 is received at synthetic profile generation compute device 120 from user compute device 140 via network 160. In some implementations, 406 can occur before 402 and/or 404, in parallel with 402 and/or 404, and/or automatically (e.g., without human intervention) in response to completing 402 and/or 404.

At 408, a set of text associated with the occupational code is identified from a database (e.g., database 128) that includes a plurality of sets of texts associated with a plurality of occupational codes. The plurality of occupational codes includes the occupational code. In some implementations, 408 occurs automatically (e.g., without human intervention) in response to completing 402, 404, and/or 406.

At 410, for each text from the subset of text and to generate a set of candidate texts (e.g., set of candidate texts 132) associated with that subset of text, text from the set of text having semantic similarity to that text is identified. In some implementations, 410 occurs automatically (e.g., without human intervention) in response to completing 408.

At 412, a subset of candidate texts (e.g., subset of candidate texts 132) is generated from the set of candidate texts based on the criterion. In some implementations, 412 occurs automatically (e.g., without human intervention) in response to completing 410.

At 414, a machine learning model (e.g., ML model 134) is executed to generate a synthetic profile (e.g., synthetic profile 136) for the job description based on the subset of candidate texts. The machine learning model is trained using training data that includes a predetermined ratio of a first type of skill (e.g., hard skill, non-filler skill) and a second type of skill different than the first type of skill (e.g., filler skill, soft skill). The predetermined ratio is predetermined based on the occupational code. In some implementations, 414 occurs automatically (e.g., without human intervention) in response to completing 412.

At 416, the synthetic profile is caused to be output. With reference to FIG. 1, 416 could include, for example, sending an electronic signal representing the synthetic profile from synthetic profile generation compute device 120 to user compute device 140, where user compute device 140 is configured to output the synthetic profile in response to receiving the electronic signal. In some implementations, 416 occurs automatically (e.g., without human intervention) in response to completing 414.

At 418, an indication indicating approval or disapproval of the synthetic profile is received. With reference to FIG. 1, 418 could include, for example, synthetic profile generation compute device 120 receiving an electronic signal from user compute device 140 indicating that the synthetic profile has been approved or disapproved (e.g., by user U).

In some implementations of method 400, the indication indicating approval or disapproval of the synthetic profile at 418 indicates disapproval of the synthetic profile. Some implementations of method 400 further include receiving an indication of a reason for disapproval of the synthetic profile. Some implementations of method 400 further include causing, in response to receiving the reason and without human intervention, the job description to be updated based on the reason.

In some implementations of method 400, each candidate text from the set of candidate texts is associated with a commonality score from a plurality of commonality scores. In some implementations of method 400, generating the subset of candidate texts at 412 includes determining a desirability score associated with the criterion and, for each candidate text from the set of candidate texts, determining whether that candidate text should be included in the subset of candidate texts based on a comparison between the commonality score from the plurality of commonality scores associated with the candidate text and the desirability score.

In some implementations of method 400, first type of skill is hard skills and the second type of skill is filler skills.

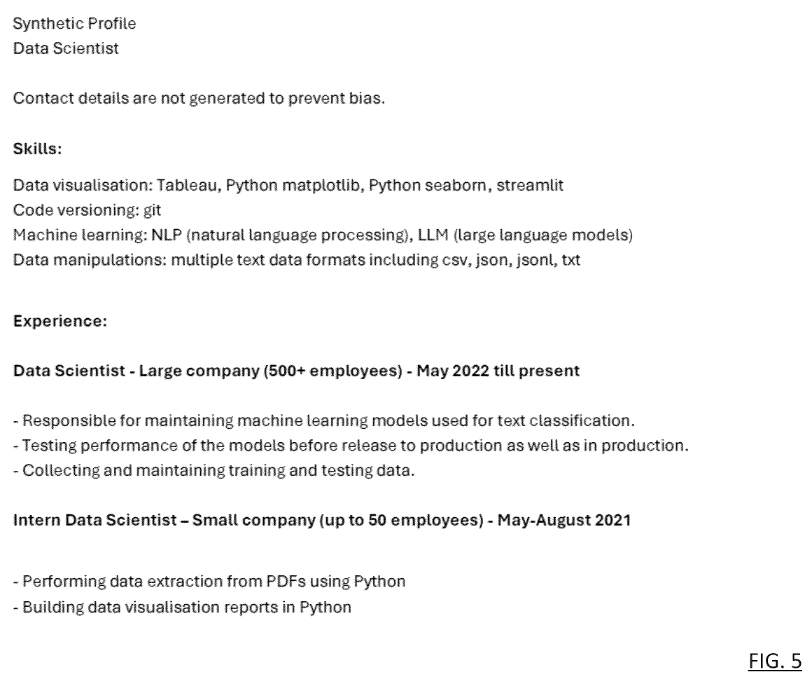

FIG. 5 illustrates an example synthetic profile for a data scientist, according to an embodiment. The synthetic profile illustrated at FIG. 5 is an example of a synthetic profile (e.g., synthetic profile 136) that can be generated (e.g., by ML model 134) based on a job description (e.g., text 146) and/or set of criteria (e.g., set of criteria 148).

As illustrated at FIG. 5, the synthetic profile does not include contact details (e.g., name, email address, phone number, address, etc.) to prevent bias. Further the synthetic profile includes a description of skills and experiences for the hypothetical job candidate. The skills include: data visualization skills of Tableau, Python matplotlib, Python seaborn, streamlit; code versioning skill of git; machine learning skills of NLP (natural language processing) and LLM (large language models); and data manipulations skills of multiple text data formats including csv, json, jsonl, and txt. The experiences include: being a data scientist at a large company (500+ employees) from May 2022 until present, where the hypothetical candidate was responsible for maintaining machine learning models used for text classification, testing performance of the models before release to production as well as in production, and collecting and maintaining training and testing data; and being an intern data scientist at a small company (up to 50 employees) from May 2021 to August 2021, where the hypothetical candidate was responsible for performing data extraction from PDFs using Python and building data visualization reports in Python.

Although some implementations herein were discussed in the context of jobs and candidates, techniques described herein can be applied in any settings such as ranking restaurants, ranking hotels, ranking products, and/or ranking results for any search query.

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the embodiments, “set” can refer to zero or more in some implementations, one or more in some implementations, and two or more in some implementations.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

1. A method, comprising:
augmenting preliminary training data to generate training data, the training data being larger than the preliminary training data, the training data having more variety than the preliminary training data;
training a machine learning model using the training data, the training data including a predetermined ratio of a first type of skill and a second type of skill different than the first type of skill, the predetermined ratio predetermined based on an occupational code, training the machine learning model including (1) identifying, by an additional model, an error generated by the machine learning model and (2) inputting the error to the machine learning model in response to identifying the error;
receiving, via a processor, a representation of a text associated with the occupational code;
receiving, via the processor, a representation of a criterion associated with the text;
extracting, via the processor, a representation of a subset of text from the text;
for each text from the subset of text and not for remaining text from the text, and to generate a set of candidate texts associated with the subset of text, identifying, via the processor and using a database that includes a plurality of texts, text from the plurality of texts that have semantic similarity to that text greater than a predetermined threshold;
identifying, via the processor, a subset of candidate texts from the set of candidate texts based on the criterion;
generating, via the processor, without using personal data, without inputting the subset of text or the text into the machine learning model, and using the machine learning model, a synthetic profile associated with the text based on the subset of candidate texts;
causing, via the processor, a representation of the synthetic profile to be output; and
generating, in response to the synthetic profile being disapproved and using the machine learning model, an updated version of the synthetic profile based on at least one of an updated version of the text or an updated version of the criterion.

2. The method of claim 1, wherein the text is a first text, the subset of text is a first subset of text, the set of candidate texts is a first set of candidate texts, the subset of candidate texts is a first subset of candidate texts, and the synthetic profile is a first synthetic profile, the method further comprising:
receiving, via the processor and after the first synthetic profile is caused to be output, a representation of a second text different than the first text;
extracting, via the processor, a representation of a second subset of text from the second text;
for each text from the second subset of text and not for remaining text from the second text, and to generate a second set of candidate texts associated with the second subset of text and different than the first set of candidate texts, identifying, via the processor and using the database, text from the plurality of texts that have semantic similarity to that text greater than the predetermined threshold;
identifying, via the processor, a second subset of candidate texts from the second set of candidate texts based on the criterion;
generating, via the processor, a second synthetic profile associated with the second text based on the second subset of candidate texts; and
causing, via the processor, a representation of the second synthetic profile to be output.

3. The method of claim 1, wherein the text is a first text, the criterion is a first criterion, the subset of text is a first subset of text, the set of candidate texts is a first set of candidate texts, the subset of candidate texts is a first subset of candidate texts, and the synthetic profile is a first synthetic profile, the method further comprising:
receiving, via the processor and after the first synthetic profile is caused to be output, a representation of a second text different than the first text;
receiving, via the processor, a representation of a second criterion that is associated with the text and different than the first criterion;
extracting, via the processor, a representation of a second subset of text from the second text;
for each text from the second subset of text and not for remaining text from the second text, and to generate a second set of candidate texts associated with the second subset of text and different than the first set of candidate texts, identifying, via the processor and using the database, text from the plurality of texts that have semantic similarity to that text greater than the predetermined threshold;
identifying, via the processor, a second subset of candidate texts from the second set of candidate texts based on the second criterion;
generating, via the processor, a second synthetic profile associated with the second text based on the second subset of candidate texts; and
causing, via the processor, a representation of the second synthetic profile to be output.

4. The method of claim 1, wherein the criterion is a first criterion, the subset of candidate texts is a first subset of candidate texts, and the synthetic profile is a first synthetic profile, the method further comprising:
receiving, via the processor and after the first synthetic profile is caused to be output, a representation of a second criterion that is associated with the text and different than the first criterion;
identifying, via the processor, a second subset of candidate texts from the set of candidate texts based on the second criterion and not the first criterion;
generating, via the processor, a second synthetic profile associated with the text based on the second subset of candidate texts and not the first subset of candidate texts; and
causing, via the processor, a representation of the second synthetic profile to be output.

5. The method of claim 1, wherein the plurality of texts is a first plurality of texts associated with the occupational code, the occupational code is from a plurality of occupational codes, and the database further includes texts not associated with the occupational code, the method further comprising:
refraining from determining semantic similarity between (1) text from the texts not associated with the occupational code and (2) text from the subset of text.

6. The method of claim 1, wherein each candidate text from the set of candidate texts is associated with a commonality score from a plurality of commonality scores, and identifying the subset of candidate texts from the set of candidate texts includes:
determining a desirability score associated with the criterion; and
for each candidate text from the set of candidate texts, determining whether that candidate text should be included in the subset of candidate texts based on a comparison between the commonality score from the plurality of commonality scores associated with that candidate text and the desirability score.

7. The method of claim 1, wherein:
the text is a job description,
the criterion is one of a salary, benefit, or years of experience, and
the subset of text includes at least one of a skill or an experience.

8. The method of claim 1, further comprising:
receiving an indication that the updated version of the synthetic profile is approved;
causing, in response to receiving the indication that the updated version of the synthetic profile is approved, the updated version of the text to be accessible by a plurality of candidates;
receiving, in response to the updated version of the text being accessible by the plurality of candidates, a plurality of candidate profiles associated with the plurality of candidates; and
causing, a hiring action associated with the updated version of the text based on the plurality of candidate profiles.

9. The method of claim 1, further comprising:
determining, for each text from the subset of text, whether that text is associated with bias; and
for each text from the subset of text associated with bias, outputting an indication that that text is associated with bias.

10. The method of claim 1, wherein the machine learning model is a transformer machine learning model.

11. The method of claim 1, wherein receiving the representation of the criterion associated with the text includes:
extracting, via the processor and without human intervention, the criterion from the text.

12. The method of claim 1, further comprising:
receiving an indication that the synthetic profile is disapproved;
receiving an indication of a reason for disapproval of the synthetic profile; and
updating, in response to receiving the reason, the text based on the reason.

13. An apparatus, comprising:
a memory; and
a processor operatively coupled to the memory, the processor configured to:
augment preliminary training data to generate training data, the training data being larger than the preliminary training data, the training data having more variety than the preliminary training data;
train a machine learning model using the training data, the training data including a predetermined ratio of a first type of skill and a second type of skill different than the first type of skill, the predetermined ratio predetermined based on an occupational code, training the machine learning model including (1) identifying, by an additional model, an error generated by the machine learning model and (2) inputting the error to the machine learning model in response to identifying the error;
receive a representation of a text associated with the occupational code;
receive a representation of a criterion associated with the text;
extract a representation of a subset of text from the text;
for each text from the subset of text and not for remaining text from the text, and to generate a set of candidate texts associated with the subset of text, identify, using a database that includes a plurality of texts associated with the occupational code, text from the plurality of texts that have semantic similarity to that text greater than a predetermined threshold;
identify a subset of candidate texts from the set of candidate texts based on the criterion;
input the subset of candidate texts to the machine learning model to generate, without using personal data and without inputting the subset of text or the text into the machine learning model, a synthetic profile associated with the text;
cause a representation of the synthetic profile to be output;
receive indication that the synthetic profile is approved;
receive a non-synthetic profile associated with the text after receiving the indication that the synthetic profile is approved; and
generate, in response to receiving the non-synthetic profile and automatically without user intervention, a hiring score for the non-synthetic profile based on the synthetic profile and the text.

14. The apparatus of claim 13, wherein the synthetic profile has the predetermined ratio of the first type of skill and the second type of skill.

15. The apparatus of claim 13, wherein the machine learning model is a transformer machine learning model.

16. The apparatus of claim 13, wherein each candidate text from the set of candidate texts is associated with a commonality score from a plurality of commonality scores, and identifying the subset of candidate texts from the set of candidate texts includes:
determining a desirability score associated with the criterion; and
for each candidate text from the set of candidate texts, determining whether that candidate text should be included in the subset of candidate texts based on a comparison between the commonality score from the plurality of commonality scores associated with the candidate text and the desirability score.

17. A non-transitory, processor-readable medium storing code representing instructions to be executed by one or more processors, the instructions comprising code to cause the one or more processors to:
augment preliminary training data to generate training data, the training data being larger than the preliminary training data, the training data having more variety than the preliminary training data;
train a machine learning model using the training data, the training data including a predetermined ratio of a first type of skill and a second type of skill different than the first type of skill, the predetermined ratio predetermined based on an occupational code, training the machine learning model including (1) identifying, by an additional model, an error generated by the machine learning model and (2) inputting the error to the machine learning model in response to identifying the error
receive a representation of a job description associated with the occupational code;
extract a subset of text from the job description, the subset of text including at least one of a skill or an experience;
receive a representation of a criterion associated with the job description;
identify a set of text associated with the occupational code from a database that includes a plurality of sets of texts associated with a plurality of occupational codes, the plurality of occupational codes including the occupational code;
for each text from the subset of text and to generate a set of candidate texts associated with that subset of text, identify text from the set of text having semantic similarity to that text;
generate a subset of candidate texts from the set of candidate texts based on the criterion;
execute the machine learning model to generate a synthetic profile for the job description based on the subset of candidate texts, without inputting the subset of text or the job description into the machine learning model, and without using personal data;
cause the synthetic profile to be output; and
generate, in response to the synthetic profile being disapproved, an updated version of the synthetic profile based on at least one of an updated version of the job description or an updated version of the criterion.

18. The non-transitory processor-readable medium of claim 17, the instructions further comprise code to cause the one or more processors to:
receive an indication of a reason for disapproval of the synthetic profile; and
cause, in response to receiving the reason and without human intervention, the job description to be updated based on the reason.

19. The non-transitory processor-readable medium of claim 17, wherein each candidate text from the set of candidate texts is associated with a commonality score from a plurality of commonality scores, the instructions to generate the subset of candidate texts further including code to cause the one or more processors to:
determine a desirability score associated with the criterion; and
for each candidate text from the set of candidate texts, determine whether that candidate text should be included in the subset of candidate texts based on a comparison between the commonality score from the plurality of commonality scores associated with the candidate text and the desirability score.

20. The non-transitory processor-readable medium of claim 17, wherein the first type of skill is hard skills and the second type of skill is filler skills.
